(19) United States
(12) Patent Application Publication
(10) Pub. No.: US 2025/0125494 A1
(43) Pub. Date: Apr. 17, 2025

(54) ANTI-DEFLECTION SPRING STRUCTURE AND BATTERY COMPARTMENT

(71) Applicant: TILTA INC., Burbank, CA (US)

(72) Inventors: Jiawen KANG, Shenzhen (CN); Wenping ZENG, Shenzhen (CN); Kefeng ZHOU, Shenzhen (CN)

(21) Appl. No.: 18/903,420

(22) Filed: Oct. 1, 2024

(30) Foreign Application Priority Data
Oct. 13, 2023 (CN) 2023227607328

(51) Int. Cl. H01M 50/503; H01M 50/103; H01M 50/24; H01M 50/271; H01M 50/289

(52) U.S. Cl. CPC H01M 50/503; H01M 50/103; H01M 50/24; H01M 50/271; H01M 50/289

(57) ABSTRACT

The present disclosure pertains to an anti-deflection spring structure. The spring structure includes a support ring, a bent connecting segment, and a supporting spring. One end of the bent connecting segment is joined to the supporting spring, while the other end is bent towards and attached to the support ring, ensuring that the opposing ends of the support ring align on a common plane. When the support ring is mounted on an external structure, the spring structure is subjected to lateral compression from the side of the supporting spring opposite the support ring, rendering it resistant to tilting and effectively preventing dislodgement.

### CROSS-REFERENCE TO RELATED APPLICATIONS

The present application for patent claims priority to and the benefit of pending Chinese Application No. 2023227607328, filed Oct. 13, 2023, and hereby expressly incorporated by reference herein as if fully set forth below in its entirety and for all applicable purposes.

### TECHNICAL FIELD

The present disclosure pertains to the realm of springs, specifically addressing an anti-deflection spring structure.

### INTRODUCTION

In contemporary battery compartments, springs are incorporated to accommodate batteries. Upon battery installation, one end of the battery presses against and compresses the spring. However, conventional springs, constructed with sequentially fixed spring coil turns forming a spiral ascending structure, often exhibit non-uniform parallelism with the horizontal plane, with some coils inclined. This configuration predisposes the spring to tilting and deflection during compression, potentially leading to slippage between the battery and spring.

### BRIEF SUMMARY

In light of the aforementioned challenges, the present disclosure aims to devise an anti-deflection spring structure that minimizes deflection and tilting under compression.

Additionally, it endeavors to present a battery compartment where the spring structure, upon being compressed by the battery, remains resilient to deflection and tilting, thereby eliminating slippage between the two components.

To accomplish these objectives, the technical approach of the present disclosure is as follows.

An anti-deflection spring structure that comprises a support ring, a bent connecting segment, and a supporting spring. a first end of the bent connecting segment is connected to the supporting spring, and a second end of the bent connecting segment is bent towards and connected to the support ring, so that two opposing ends of the support ring align on a common plane.
wherein a diameter of the supporting spring is configured to taper from a side proximal to the support ring to a distal side.
wherein the supporting spring comprises a plurality of spring coil turns arranged in a spiral configuration in order.
wherein one end of the supporting spring distant from the bent connecting segment is bent inward.
wherein the support ring, the bent connecting segment, and the supporting spring are configured to be integrally formed.

A battery compartment, comprising a battery chamber for mounting a battery; the battery chamber is provided with a spring structure; wherein the spring structure comprising a support ring, a bent connecting segment, and a supporting spring; a first end of the bent connecting segment is connected to the supporting spring, and a second end of the bent connecting segment is bent towards and connected to the support ring, so that two opposing ends of the support ring align on a common plane.
wherein the battery compartment is provided with a connecting chamber; a connecting channel is positioned on one side of the battery chamber adjacent to the connecting chamber, facilitating communication between the battery chamber and the connecting chamber; the support ring is provided within the connecting chamber, the supporting spring is provided within the battery chamber, and the bent connecting segment bridges the gap through the connecting channel.
wherein the battery compartment comprises a housing and a battery cover, while the housing comprises the battery chamber; the battery cover is configured to connected to the housing rotatably, covering and protecting the battery chamber.
wherein the housing comprises a first housing and a second housing, an opposing side of the first housing and the second housing is respectively provided with a first protrusion and a second protrusion; the battery cover is rotatably connected at both ends to the first protrusion and the second protrusion, respectively.
wherein the first housing is provided with a first housing groove, and the first housing groove is provided with a first card; this first card divides the first housing groove into a first battery groove and a first card slot; a first connection gap is formed along one side of the first card; the second housing is provided with a second housing groove, and the second housing groove housing a second card, dividing the second housing groove into a second battery groove and a second card slot, with a second connection gap present on one side of the second card; the first and second housings are designed to be detachably connected; The first housing is detachably connected to the second housing, the first battery groove and second battery groove can form the battery chamber, while the first card slot and the second card slot can form the connecting chamber; the first connection gap and the second connection gaps can forming the connecting channel; the support ring is positioned with opposite ends nestled within the first card slot and the second card slot, respectively.

The beneficial effects of the present disclosure stem from the design that when the support ring is mounted on an external structure, the spring structure is subjected to lateral compression from the side of the supporting spring opposite the support ring, positioning the support ring's opposing ends within a shared plane and rendering the spring structure resistant to tilting and effectively preventing dislodgement.

### BRIEF DESCRIPTION OF THE DRAWINGS

FIG. 1 is a schematic diagram of the spring structure according to some aspects of the disclosure.

FIG. 2 is a sectional view of a battery compartment without a battery installed according to some aspects of the disclosure.

FIG. 3 is an exploded view of a battery, a housing, and a spring structure according to some aspects of the disclosure.

FIG. 4 is a schematic diagram of a first housing according to some aspects of the disclosure.

FIG. 5 is a schematic diagram of a second housing according to some aspects of the disclosure.

FIG. 6 is an exploded view of the battery compartment according to some aspects of the disclosure.

FIG. 7 is an enlarged view of a portion of FIG. 6.

### DRAWING LABEL EXPLANATIONS

1—spring structure; 11—support ring; 111—a first end; 112—a second end; 12—bent connecting segment; 13—supporting spring; 131—spring coil turn; 14—battery side;
2—battery compartment; 21—battery chamber; 22—connecting chamber; 23—connecting channel; 24—housing; 241—first housing; 2411—first protrusion; 242—second housing; 2421—second protrusion; 243—elastic member; 2431—torsion spring; 25—battery cover; 26—first housing groove; 261—first battery groove; 262—first card slot; 263—first connecting gap; 27—second housing groove; 271—second battery groove; 272—second card slot; 273—second connecting gap; 28—first card; 29—second card;
3—battery.

### DETAILED DESCRIPTION

To clarify the objectives, technical solutions, and aspects of the present disclosure, the following detailed explanations are provided in conjunction with the accompanying drawings and examples. It is important to note that the specific embodiments presented herein serve solely as illustrative examples and are not intended to restrict the scope of the present disclosure.

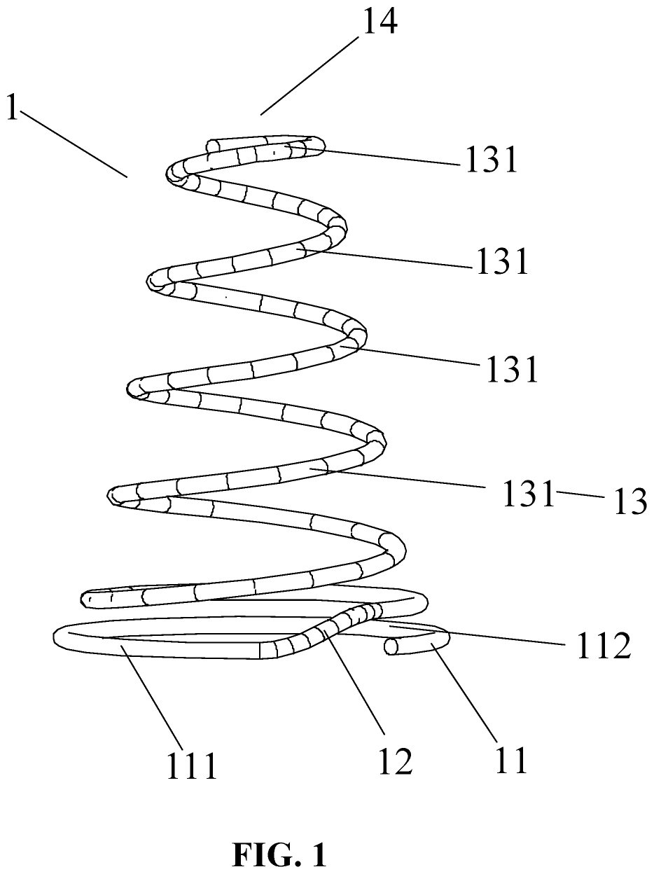

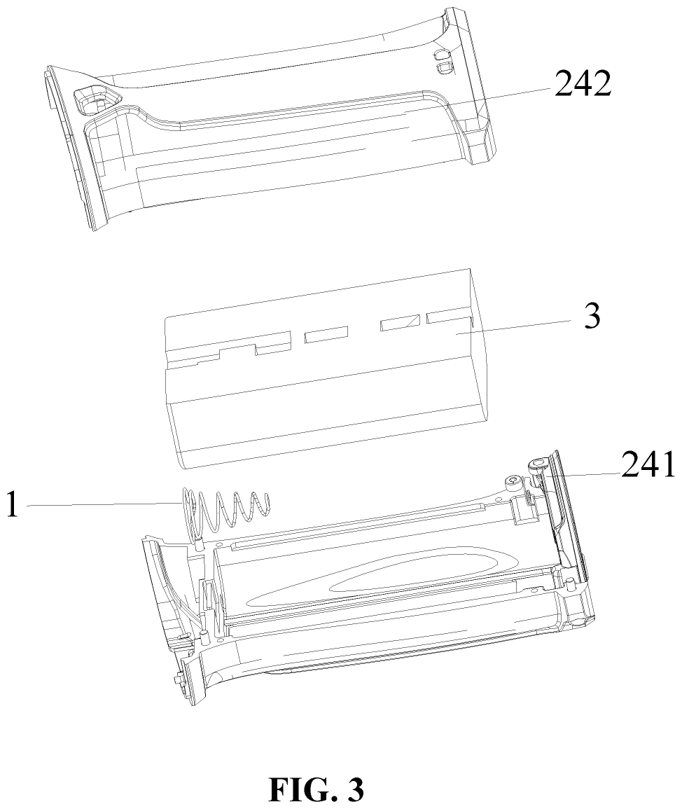

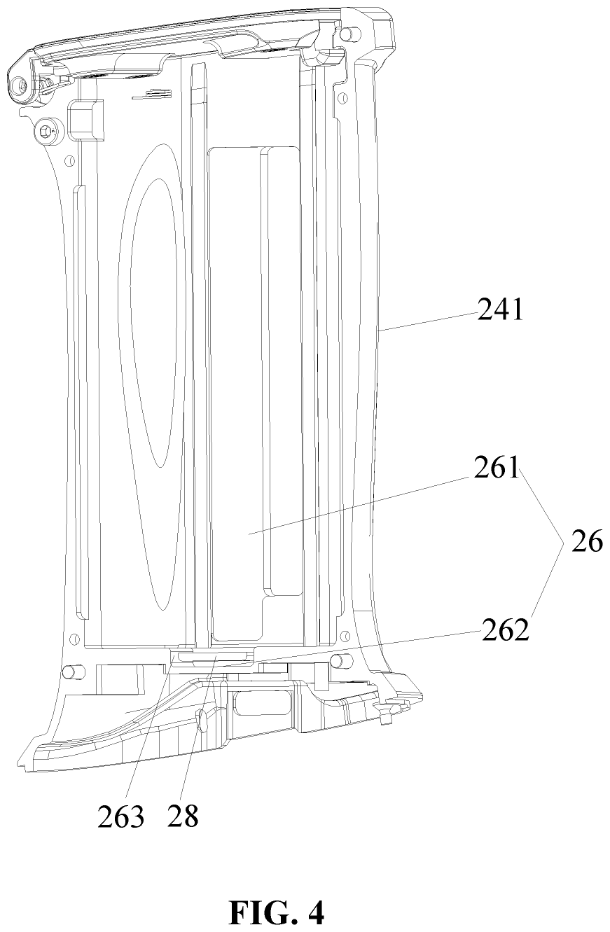

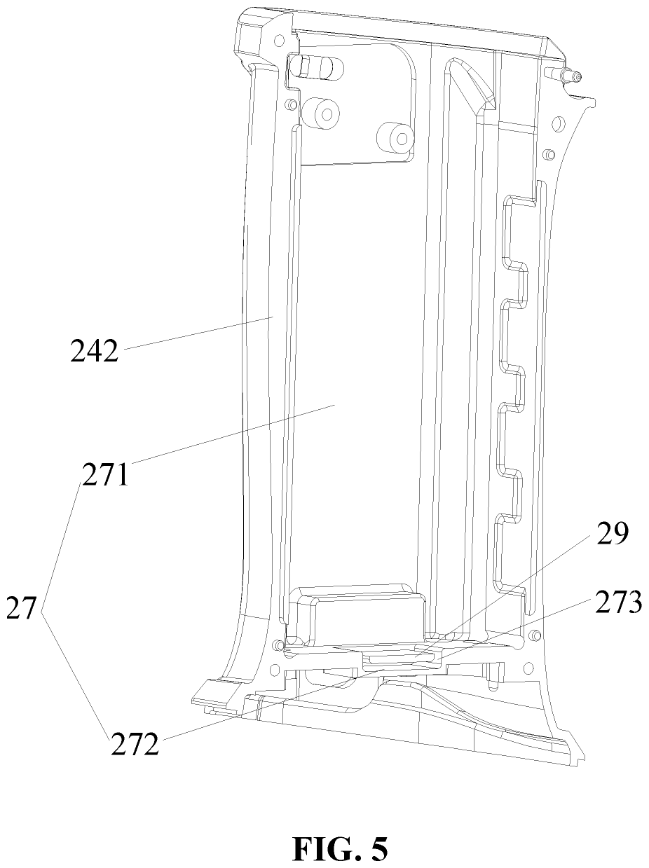

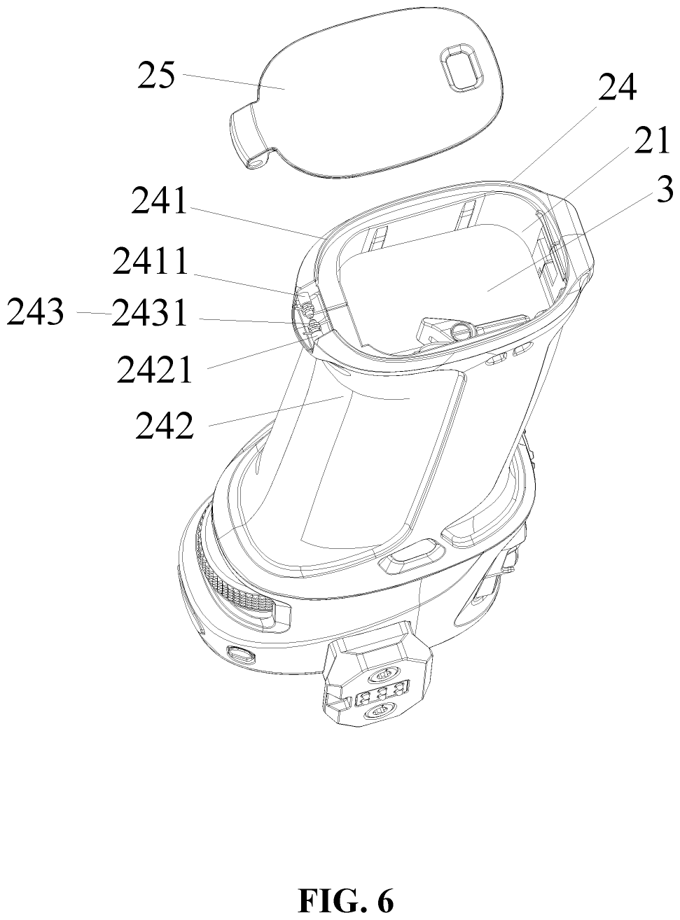

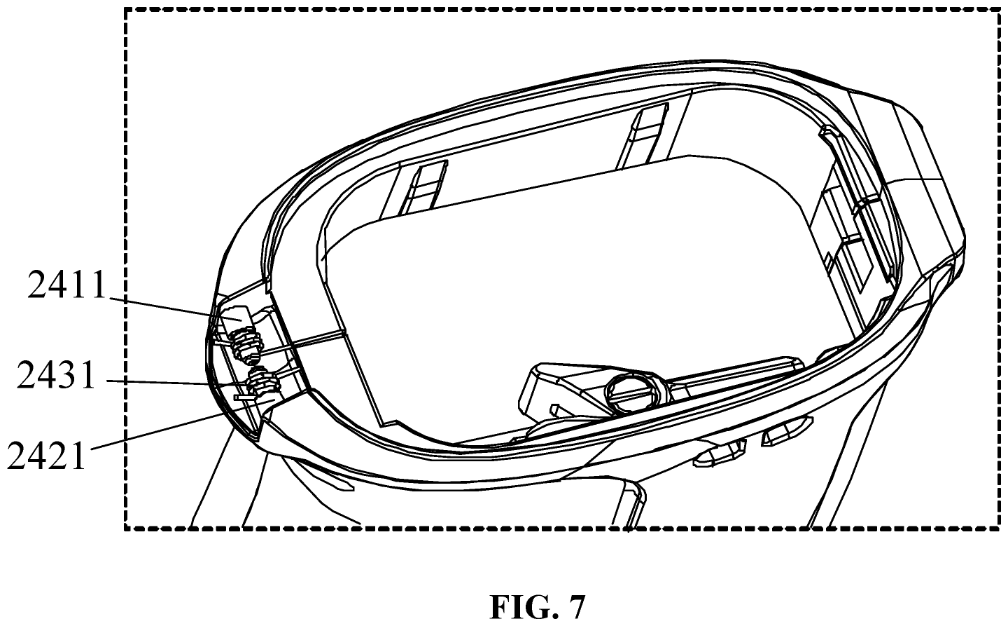

As depicted in FIGS. 1-7, an anti-deflection spring structure 1 includes a support ring 11, a bent connecting segment 12, and a supporting spring 13. Further, the support ring 11 exhibits an unclosed ring structure at both ends, with the opposing ends (a first end 111 of the support ring 11 and a second end 112 of the support ring 11) residing in the same plane, ensuring parallelism. One end of the support ring 11 can be securely connected to one end of the bent connecting segment 12, proximal to the support ring 11, while the distal end of the bent connecting segment 12 is firmly attached to the supporting spring 13. This design enables the spring structure 1, when installed within an external framework and subjected to compression from the side of the supporting spring 13 opposite the support ring 11, to exhibit enhanced resistance to tilting, to effectively prevent the occurrence of deflection in the spring structure 1.

In this example, the diameter of the supporting spring 13 tapers from the end proximal to the support ring 11 towards the opposite end, resulting in an overall circular truncated cone or conical shape for the entire spring structure 1. This tapering diameter and conical configuration facilitate the self-correction of the position of the spring structure 1 during compression, even in the presence of minor deviations at the end farther from the support ring 11.

In this example, the supporting spring 13 includes a plurality of sequentially arranged helical spring coil turns 131, wherein the diameter of these spring coil turns 131 gradually tapers from the one spring coil turn proximate to the support ring 11 towards the one spring coil turn distal from the support ring 11.

In this example, the end of the supporting spring 13, apart from the bent connecting segment 12, is bent inwards (e.g., toward the top spring coil 131). This inward-bent end serves as a support surface, for instance, to hold an external battery in place. By bending this end inwards, it effectively prevents scratching of the battery's base when resting on the end of the supporting spring 13 apart from the bent connecting segment 12.

In this example, the support ring 11, bent connecting segment 12, and supporting spring 13 are integrally formed as a single unit. For example, the entire spring structure 1 can be fabricated by bending a single metal wire or strip to form the support ring 11, connecting segment 12, and supporting spring 13. The process involves initially wrapping the wire/strip to form the support ring 11, subsequently bending it obliquely upwards at one end of the ring to create the bent connecting segment 12, and finally, continuously wrapping and bending the wire/strip in a helical pattern to form the multiple spring coil turns 131, thereby constructing the supporting spring 13.

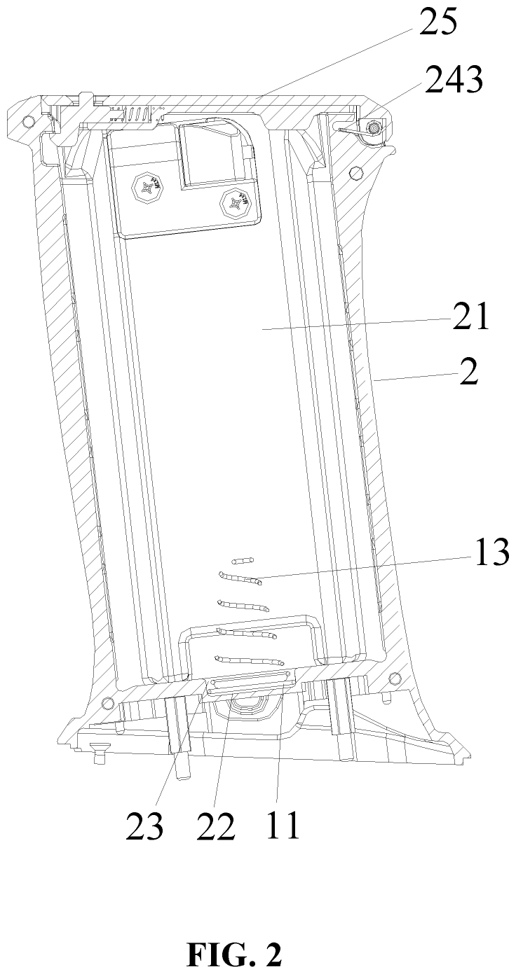

As depicted in FIGS. 2-6, a battery compartment 2 incorporates a battery chamber 21 designed to accommodate a battery 3. The spring structure 1 is positioned within this battery chamber 21. In some aspects, the spring structure 1 includes a support ring 11, a bent connecting segment 12, and a supporting spring 13. A first end of the bent connecting segment 12 is connected to the supporting spring 13, and a second end of the bent connecting segment 12 is bent towards and connected to the support ring 11, so that two opposing ends (a first end 111 of the support ring 11 and a second end 112 of the support ring 11) of the support ring 11 align on a common plane. This configuration ensures that, when the support ring 11 is installed within the battery chamber 21, the battery 3 exerts a compressive force on the spring structure 1 from the battery side 14 of the supporting spring 13 opposite the support ring 11. This arrangement not only strengthens the spring structure's resistance to tilting but also significantly reduces the likelihood of the battery 3 slipping off the spring structure.

In this example, a connecting chamber 22 is integrated within the battery compartment 2. A connecting channel 23 is positioned on one side of the battery chamber 21 adjacent to the connecting chamber 23, facilitating communication between the battery chamber 21 and the connecting chamber 22. The support ring 11 is housed within the connecting chamber 22, the supporting spring 13 resides at least partial within the battery chamber 21, and the bent connecting member 12 bridges the gap through the connecting channel 23. To further enhance connection stability, the support ring 11 of the spring structure 1 is inserted into the connecting chamber 22 within the battery compartment 2, thereby solidifying the integration between the spring structure 1 and the battery compartment 2.

In this example, the battery compartment 2 includes a housing 24 and a battery cover 25, while the housing 24 incorporates the battery chamber 21 described above. The battery cover 25 is designed to attach to the housing 24 rotatably (e.g., hinged), covering and protecting the battery chamber 21.

In this example, the housing 24 includes a first housing 241 and a second housing 242, each equipped with opposing protrusions-a first protrusion 2411 on the first housing 241 and a second protrusion 2421 on the second housing 242. The battery cover 25 is rotatably connected at both ends to the first and second protrusions 2411 and 2421, respectively. The arrangement of the first protrusion 2411 and the second protrusion 2421 effectively eliminates the need for a separate rotating shaft for rotatably installing the battery cover 25, thereby reducing the costs associated with mold design and production.

In this example, an elastic member 243 is integrated between the housing 24 and the battery cover 25 to facilitate smooth rebound and resetting mechanisms. Upon rotating the battery cover 25 open from the housing 24, the elastic member 243 exerts a force that aids in the automatic closure and resetting of the battery cover.

In some aspects, the elastic member 243 employed in this example is a torsion spring 2431, wherein its two ends are securely fastened onto the first protrusion 2411 and the second protrusion 2421, respectively.

On the first housing 241, a first housing groove 26 is incorporated, within which resides a first card 28. This first card 28 divides the groove 26 into a first battery groove 261 and a first card slot 262. A first connection gap 263 is formed along one side of the first card 28. Similarly, the second housing 242 features a second housing groove 27 housing a second card 29, dividing the second housing groove 27 into a second battery groove 271 and a second card slot 272, with a second connection gap 273 present on one side of the second card 29. The first and second housings 241 and 242 are designed to be detachably connected. When joined, the first battery groove 261 and second battery groove 271 coalesce to form the battery chamber 21, while the first card slot 262 and second card slot 272 unite to create the connecting chamber 22. Additionally, the first and second connection gaps 263 and 273 align, forming the connecting channel 23. The aforementioned design of the battery compartment 2, including the first housing 241 and the second housing 242, simplifies the assembly process of the battery compartment 2 with the spring structure 1. Moreover, the installation of the spring structure 1, achieved by clamping its opposing ends of the support ring 11 into the first card slot 262 and the second card slot 26, respectively, effectively mitigates any potential deformation of the spring structure 1 during use.

It is important to note that the above descriptions represent only preferred embodiments of the present disclosure and are not intended to restrict its scope. Any variations, equivalent substitutions, or improvements that adhere to the spirit and fundamental principles of the invention shall be deemed as falling within the scope of protection granted by the present disclosure.

What is claimed is:

1. An anti-deflection spring structure, comprising a support ring, a bent connecting segment, and a supporting spring;
wherein a first end of the bent connecting segment is connected to the supporting spring, and a second end of the bent connecting segment is bent towards and connected to the support ring, so that two opposing ends of the support ring align on a common plane.

2. The anti-deflection spring structure according to claim 1, wherein a diameter of the supporting spring is configured to taper from a side proximal to the support ring to a distal side.

3. The anti-deflection spring structure according to claim 1, wherein the supporting spring comprises a plurality of spring coil turns arranged in a spiral configuration in order.

4. The anti-deflection spring structure according to claim 1, wherein one end of the supporting spring distant from the bent connecting segment is bent inward toward the support ring.

5. The anti-deflection spring structure according to claim 4, wherein the support ring, the bent connecting segment, and the supporting spring are integrally formed.

6. A battery compartment, comprising:
a battery chamber for mounting a battery,
wherein the battery chamber is provided with a spring structure; and
wherein the spring structure comprises a support ring, a bent connecting segment, and a supporting spring, a first end of the bent connecting segment being connected to the supporting spring, and a second end of the bent connecting segment being bent towards and connected to the support ring, so that two opposing ends of the support ring align on a common plane.

7. The battery compartment according to claim 6, wherein the battery compartment is provided with a connecting chamber;
a connecting channel is positioned on one side of the battery chamber adjacent to the connecting chamber, facilitating communication between the battery chamber and the connecting chamber; and
the support ring is provided within the connecting chamber, the supporting spring is provided within the battery chamber, and the bent connecting segment bridges a gap through the connecting channel.

8. The battery compartment according to claim 7, wherein the battery compartment comprises a housing and a battery cover, and the housing comprises
the battery chamber; and
the battery cover is configured to connected to the housing rotatably, covering and protecting the battery chamber.

9. The battery compartment according to claim 8, wherein the housing comprises a first housing and a second housing, opposing sides of the first housing and the second housing are respectively provided with a first protrusion and a second protrusion; and
the battery cover is rotatably connected at a first end to the first protrusion and at a second end to the second protrusion.

10. The battery compartment according to claim 9, wherein the first housing is provided with a first housing groove, and the first housing groove is provided with a first card;
the first card divides the first housing groove into a first battery groove and a first card slot, a first connection gap being formed along one side of the first card;
the second housing is provided with a second housing groove, and the second housing groove housing a second card, dividing the second housing groove into a second battery groove and a second card slot, with a second connection gap present on one side of the second card;
the first housing is detachably connected to the second housing, the first battery groove and second battery groove form the battery chamber, and the first card slot and the second card slot forming the connecting chamber, the first connection gap and the second connection gaps forming the connecting channel; and
the support ring is positioned with opposite ends nestled within the first card slot and the second card slot, respectively.
